(19) United States
(12) Patent Application Publication
(10) Pub. No.: US 2026/0288519 A1
(43) Pub. Date: Sep. 24, 2026

(54) SELECTING AND PRE-LOADING APP DATA ON A DEVICE

(71) Applicant: Roku, Inc., San Jose, CA (US)

(72) Inventors: Frank Llewellyn Maker, Livermore, CA (US); Gregory Mack Garner, Key Colony Beach, FL (US); David Lee Stern, Los Gatos, CA (US); Brian James Hetherman, Medford, MA (US)

(73) Assignee: Roku, Inc., San Jose, CA (US)

(21) Appl. No.: 18/962,757

(22) Filed: Nov. 27, 2024

(51) Int. Cl. G06F 9/50

(52) U.S. Cl. CPC G06F 9/5016

(57) ABSTRACT

Techniques for selecting data for pre-loading onto a device and pre-loading the data into memory of the device. Certain devices, such as streaming sticks, offer a large number of apps. Pre-loading app data into memory can improve response time to load the app and offer an improved user experience. However, the memory is not large enough to pre-load app data for many apps simultaneously. As described herein, a neural network is used to determine the most likely apps for a user to load. The likelihoods are considered in combination with speedup value to pre-loading the app data as well as memory needed to pre-load the app data. A knapsack algorithm may be used to identify a set of app data for pre-loading.

### TECHNICAL FIELD

This disclosure relates generally to electronic devices and systems, and more specifically, to techniques for selecting and pre-loading app data.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 depicts a block diagram of a set of app data for pre-loading on a memory, according to some embodiments of the disclosure.

FIG. 2 illustrates example data components used by two apps, according to some embodiments of the disclosure.

FIG. 3 illustrates several arrangements of storing app data on the memory, according to some embodiments of the disclosure.

FIG. 4 illustrates an exemplary electronic system configured to pre-load data in a memory, according to some embodiments of the disclosure.

FIG. 5 illustrates a computing environment for app pre-loading that includes the electronic system and a server, according to some embodiment of the disclosure.

FIG. 6 depicts a flow diagram illustrating exemplary operations for preparing a system for selecting app data for pre-loading, according to some embodiments of the disclosure.

FIG. 7 depicts a flow diagram illustrating exemplary operations for selecting app data for pre-loading, according to some embodiments of the disclosure.

FIG. 8 depicts a flow diagram illustrating exemplary operations for initiating pre-loading data selection and pre-loading app data, according to some embodiments of the disclosure.

FIG. 9 illustrates example data components of an app that may be separately pre-loaded and a set of pre-loading combinations associated with the data components, according to some embodiments of the disclosure.

FIG. 10 depicts a block diagram of an exemplary computing device, according to some embodiments of the disclosure.

### DETAILED DESCRIPTION

### Overview

Television streaming players often provide access to multiple streaming services through which users can access different sets of content. The streaming services are also referred to as streaming platforms or over-the-top (OTT) services. For example, a ROKU streaming device may provide access to content within the ROKU channel, as well as other streaming services. To access a particular streaming service, a television streaming device executes an app associated with the streaming service. To execute an app, the streaming device loads the compiled code of the app along with various user interface resources (e.g., assets, layouts, style sheets, etc.), libraries, frameworks, configuration files, metadata, etc. into memory. In addition, the streaming device accesses relevant content information from a web server, e.g., to provide information on currently available content (e.g., live TV) or content recommendations. Different apps have different components and associated memory utilizations. For example, an app with a complex, custom user interface (UI) may require a relatively large amount of memory, whereas an app that relies on built-in UI elements provided by the streaming device itself may require a relatively small amount of memory.

Streaming devices can offer access to many apps, e.g., tens or even hundreds of different apps. Due to memory constraints, it can be impractical or impossible for a streaming device to have every available app pre-loaded in memory. For example, a user may have used and downloaded ten or twenty different apps onto a streaming device. However, due to space constraints, the streaming device may not continue to store all of these apps in memory. For example, on smaller form factor devices (e.g., streaming sticks), the random-access memory (RAM) may have capacity to store a relatively small number of apps, e.g., less than five apps at a time. If the user opens an app that is not stored in RAM, there can be a lag time while the app data is being loaded. A long lag time, e.g., a lag time of multiple seconds, is undesirable to users, particularly when loading app that the user has used in the past.

In some prior implementations, a streaming device may have one or more apps consistently pre-loaded, e.g., an app associated with the streaming device may be pre-loaded, or the streaming device may keep the most recently used app in RAM. However, this may lead to a sub-optimal user experience when the user selects an app that is not pre-loaded based on these factors.

A more intelligent method for pre-loading apps onto a streaming device is described herein. A neural network is trained to determine likelihoods that each of a set of different apps will be opened on a streaming device based on previous use of the streaming device. The neural network is trained to determine the likelihoods based on set of features or factors, such as time of day, day of week, current events, a person or people near the streaming device, and one or more recently used apps. The likelihoods are used to determine a speedup value for pre-loading the set of apps; the speedup value may be further based on the speed improvement that can be gained by pre-loading the content, e.g., by comparing the time to launch a pre-loaded app to the time to launch an app if it has not been pre-loaded. The speedup values are then considered in combination with the sizes of the set of different apps to select one or more apps for pre-loading. For example, the set of apps for pre-loading can be solved as a 0-1 knapsack problem, in which the speedup values correspond to the values, and the sizes (e.g., memory allotments) of the pre-loaded app data correspond to the weights. Solving the knapsack problem identifies a set of one or more apps for pre-loading on the streaming device.

The likelihood estimation, speedup value, and knapsack solution may be solved on a remote system, e.g., a web server in communication with the streaming device. For example, the streaming device may determine that one or more of the factors for estimating the likelihoods has changed, or the streaming device may determine that a user may soon select another app, e.g., based on presently playing content nearing its end time. The streaming device may request the web server identify a set of apps for pre-loading. Pre-loading apps that need to be downloaded to the streaming device may have drawbacks, e.g., monetary costs and/or reducing quality of the presently playing content. Thus, in some cases, the streaming device may not automatically pre-load the identified apps, but instead, the streaming device or the web server may compare the identified apps to the currently loaded apps and determine whether the set of identified apps is different from the currently loaded apps and, if so, determine whether the value of pre-loading the set of identified apps exceeds a certain threshold.

Using the described process for selecting and pre-loading selected apps may provide an improved user experience over prior pre-loading schemes. In particular, by anticipating a user's app selection and pre-loading one or more apps that the user is likely to use, the streaming device can reduce lag times for opening apps. Furthermore, by using the described approach that considers both the amount of speed that can be obtained and the amount of memory utilized by an app, the streaming device pre-loads the most valuable apps: apps that are likely to be used and apps for which pre-loading provide a speed benefit.

### Exemplary App Data for Loading in Memory

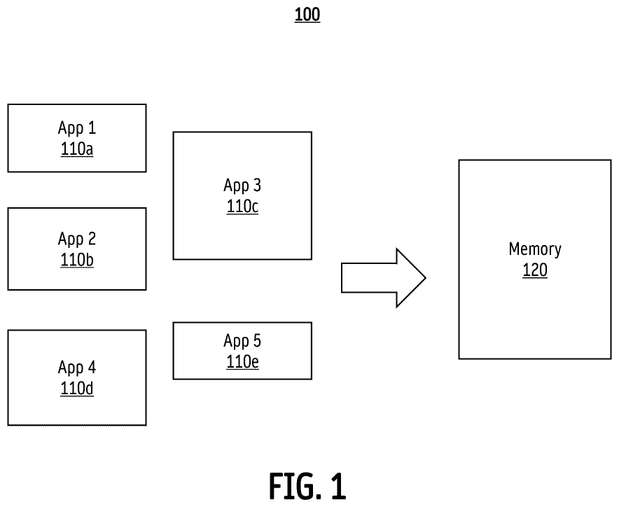

FIG. 1 depicts a block diagram of a set of app data for pre-loading on a memory of a streaming device, according to some embodiments of the disclosure. FIG. 1 represents a set of five different apps 110a, referred to as App 1 110a through App 5 110e. Apps 110 may be apps that can execute on a streaming device, e.g., to provide interfaces to different streaming services or channels. In other embodiments, Apps 110 may be apps for executing on one or more other types of devices. Each of apps 110a, 110b, 110c, 110d, and 110e is represented with a differently sized box. The sizes of the boxes correspond to the amount of app data for each app that can be pre-loaded in memory 120, i.e., an allotment of memory 120 needed to store the app data. For example, App 3 110c is larger than App 5 110c, indicating that App 3 110c has a greater amount of app data than App 5 110e, and thus a larger memory allotment in memory 120 is needed to store the app data for App 3 110c than for App 5 110e. For example, App 3 110c may have more custom UI components than App 5 110e. While five apps 110 are represented in FIG. 1, a streaming device may include any number of apps.

Memory 120 is the memory of the streaming device. Memory 120 is a RAM that stores open apps and data being processed. Memory 120 may further provide a cache and write buffer. Memory 120 can also pre-load app data so that, if a user opens a pre-loaded app, the streaming device opens the app more quickly, without having to retrieve at least a portion of the app data from local storage or from a web resource. Memory 120 may not have the capacity to store app data associated with all of the apps 110, e.g., due to the current memory usage (e.g., data for executing the operating system, implementing a buffer for currently playing content, etc.) and, in some cases, due to the large number of apps available on the streaming device. As illustrated, the total size of apps 110a-110e is greater than the size of memory 120, or more precisely, the size of the portion of the memory 120 that is available for pre-loading apps. Therefore, memory 120 is not able to pre-load app data for all five of apps 110a-110e.

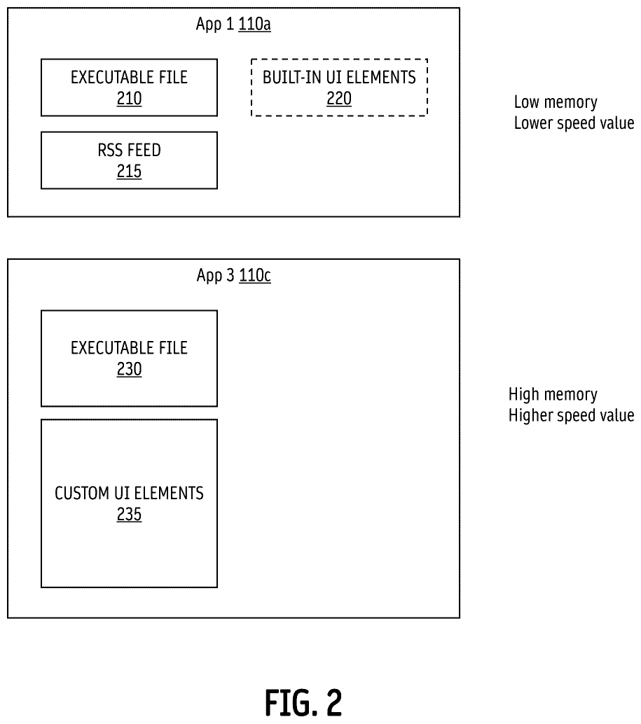

FIG. 2 illustrates example data components used by two apps, according to some embodiments of the disclosure. App 1 110a, which is one of the smaller apps represented in FIG. 1, includes an executable file 210 and an RSS feed 215. The RSS feed 215 may be pulled from a web server associated with App 1 110a. App 1 110a relies on built-in UI elements 220, which are bounded by a dotted line, indicating that these are not part of the app data of App 1 110a for pre-loading. The built-in UI elements 220 are provided by the streaming device and, therefore, may already be available in memory and, therefore, may not need to be separately loaded into memory 120 in order to execute App 1 110a.

App 3 110c, which is the largest app represented in FIG. 1, includes an executable file 230 and custom UI elements 235. The executable file 230 and custom UI elements 235 are relatively large, e.g., larger than the executable file 210 and RSS feed 215 of App 1 110c. Storing the executable file 230 and custom UI elements 235 in memory 120 requires a greater amount of memory 120 than storing the executable file 210 and RSS feed 215. The app data components illustrated in FIG. 2 are merely exemplary; each of the apps 110 may include different and/or additional app data blocks for pre-loading.

Because of the relatively small size of the app data blocks 210 and 215 for App 1 110a, pre-loading this app data utilizes a relatively small amount of memory 120. In addition, pre-loading the app data for App 1 110a may provide a relatively low speed value. By contrast, because of the larger sizes of the app data blocks 230 and 235 for App 3 110c, pre-loading this app data utilizes a relatively large amount of the memory 120. However, pre-loading the app data for App 3 110c may provide a relatively higher speed value.

While in general, the speed value is correlated with the size of the app data, in some cases, this relationship may not be observed. As an example, pre-loading the RSS feed 215 may provide an outsized speed benefit relative to its size, e.g., if the web server associated with App 1 110a is relatively slow.

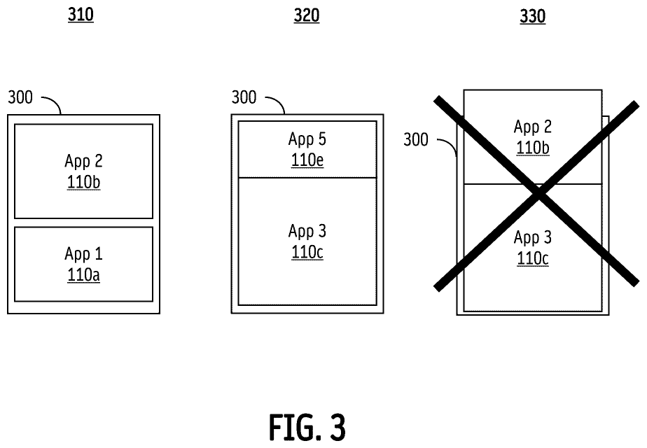

FIG. 3 illustrates several arrangements of storing app data on the memory, according to some embodiments of the disclosure. In FIG. 3, the size of box 300 represents the portion of the memory 120 that is available for pre-loading apps. As in FIG. 1, the sizes of the different app boxes 110 represent the size of pre-load data associated with the apps 110. In a first arrangement 310, App 1 110a and App 2 110b are both stored in memory 120. In a second arrangement 320, App 3 110c and App 5 110cb are both stored in memory 120. In a third arrangement 330, storing both App 2 110b and App 3 110c would exceed the available portion 300 of memory 120 that is available for pre-loading apps. Thus, App 2 110b and App 3 110c cannot both be simultaneously pre-loaded onto memory 120.

In general, in various situations, different numbers of apps 110 may be able to be pre-loaded, based on the size of the pre-load data for the individual apps 110 and, in some cases, the portion 300 of memory 120 that is available for pre-loading. For example, a greater amount of memory 120 may be available for pre-loading if the streaming device is not currently playing content than if the streaming device is currently playing content. As another example, a greater amount of memory 120 may be available for pre-loading if the streaming device is not currently executing an app than if the streaming device is currently executing an app. The amount of memory 120 for pre-loading may vary based on the currently executing app, with a larger amount available if the currently executing app has lower memory usage and vice versa.

### Exemplary Electronic System

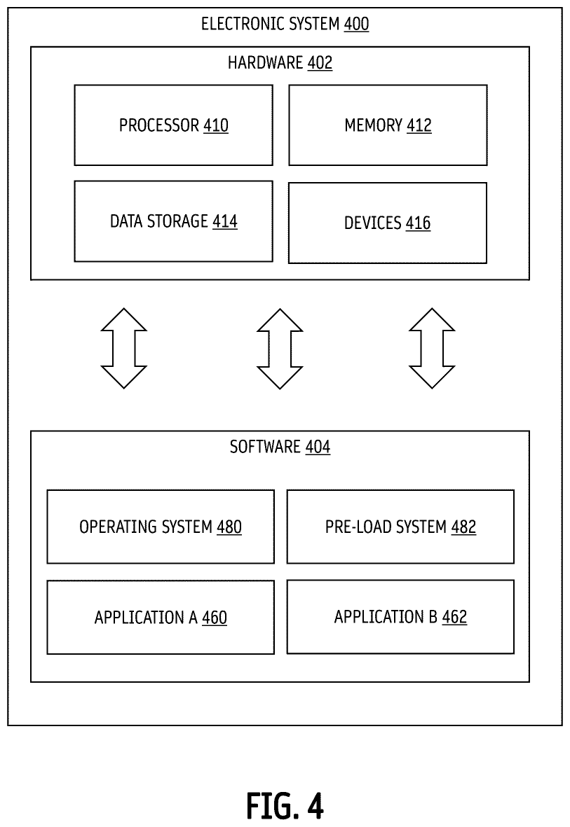

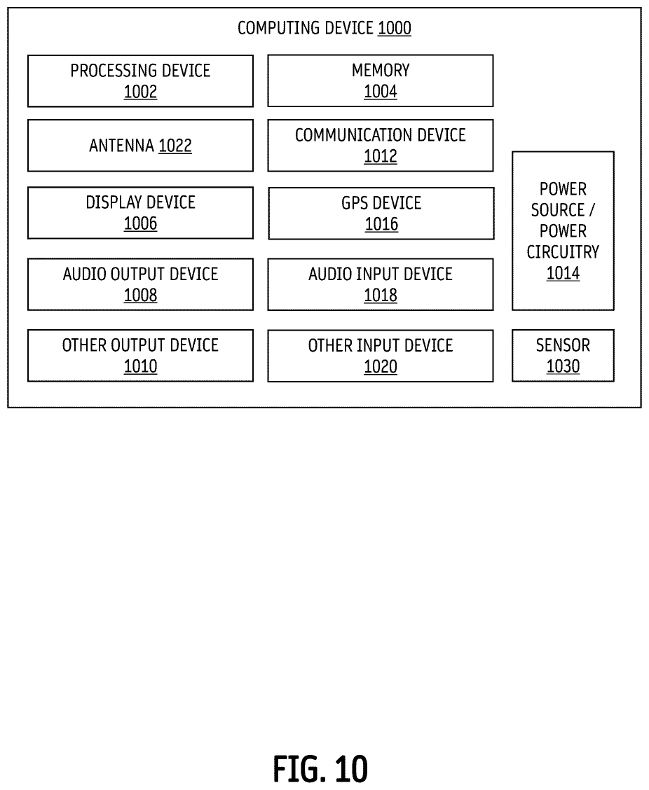

FIG. 4 depicts a block diagram of exemplary electronic system 400 configured to pre-load data in a memory, according to some embodiments of the disclosure. Electronic system 400 may in some cases be in the form of a computing device 1000 of FIG. 10. Electronic system 400 may include hardware 402 and software 404. Hardware 402 can include physical components of electronic system 400. Hardware 402 may include processor 410, memory 412, data storage 414, and one or more devices 416. Examples of one or more devices 416 can include one or more of a communication device, cryptography accelerator, decoder, light-emitting device, sensors, input device, output device, media card reader, identity module, etc.

Memory 412 may be RAM, such as memory 120 described with respect to FIGS. 1-3. Memory 412 may provide relatively fast storage and retrieval times. Data storage 414 may provide mass data storage that has slower operation than memory 412. Data storage 414 may be, for example, flash memory, read-only memory (ROM), hard drives, and other types of non-volatile memory. Data storage 414 may be used for secondary storage or longer-term storage than memory 412.

Software 404 can include instructions, data, and/or programs that can be executed by a processor (e.g., processor 410) to perform one or more tasks and/or to manipulate one or more components in hardware 402. Software 404 can include operating system 480, pre-load system 482, and one or more applications (e.g., Application A 460 and Application B 462). Applications may be subsystems of electronic system 400. Applications A 460 and B 462 may be examples of apps 110 described above. Other examples of applications may include changing colors of a light bulb based on the time of day, turning on an alarm when a sensor detects unacceptable levels of indoor air pollution, capturing video footage at a front door of a home, tracking health metrics based on sensor data, counting a number of people that has walked past an area, performing inventory counting based on sensor data, monitoring equipment performance based on sensor data, monitoring atmospheric information based on sensor data, etc.

Operating system 480 may include software that manages hardware 402 and other resources in software 404. Operating system 480 can provide services for one or more applications. Operating system 480 can act as an intermediary between an application and hardware 402. Operating system 480 can implement one or more of: process management, memory management, device management, security, and input/output management. Operating system 480 may include one or more libraries corresponding to the one or more services. A library may include a well-defined application programming interface (API). A library may include corresponding implemented functions of the API. An API may include specifications for applications to make a request or call a function. For example, a library may include an API for using a device of the one or more devices 416. An application can open a library to start a service. The application can call a function defined in the library to perform an operation using the service.

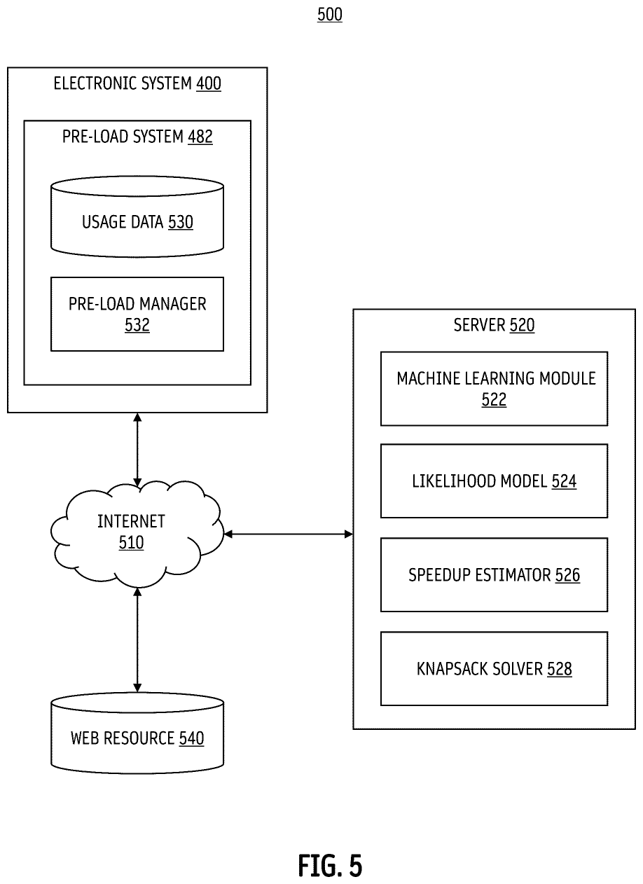

Pre-load system 482 manages pre-loading of app data into memory 412. Pre-load system 482 may determine whether to update the pre-loaded apps and determine whether to pre-load one or more different apps in memory 412. Pre-load system 482 may also initiate the pre-loading operation, including removing one or more previously pre-loaded apps from memory 412, and causing data of one or more selected apps for pre-loading to be stored in memory 412. Pre-load system 482 is described in greater detail with respect to FIGS. 5-9. While illustrated as a separate system, pre-load system 482 may be a component or module of operating system 480.

Electronic system 400 may be a streaming device for streaming content, such as video content and/or audio content. In some embodiments, electronic system 400 may be a small form-factor device, such as a dongle or a stick. In other embodiments, electronic system 400 may be a box that can be connected to a display. In still other embodiments, electronic system 400 may be a display device that includes built-in streaming functionality. In some embodiments, memory 412 may be relatively small, e.g., 2 gigabytes (GBs), 1 GB, 512 megabytes (MB), or less. Data storage 414 may also be relatively small, e.g., 4 GB, 2 GB, 1GB, or 512 MB.

### Exemplary Network Environment for Pre-Loading

FIG. 5 illustrates an exemplary computing environment for app pre-loading that includes the electronic system and a server, according to some embodiments of the disclosure. FIG. 5 includes electronic system 400, Internet 510, server 520, and web resource 540. Within electronic system 400, only pre-loading system 482 is illustrated, but it should be understood that electronic system 400 includes other components and features, as described with respect to FIG. 4.

Electronic system 400 provides a connection to the Internet 510, so that electronic systems 400 may communicate with other systems and devices, such as server 520 and web resource 540, that are connected to the Internet 510. For example, electronic system 400 may have a networking device, such as a Wi-Fi router. Electronic system 400 may additionally or alternatively provide wired connections to the Internet, e.g., using Ethernet.

Pre-loading system 482 includes usage data 530 and a pre-load manager 532. Usage data 530 describes usage of electronic system 400 by one or more users of electronic system 400. While usage data 530 is illustrated in FIG. 5 as being part of pre-load system 482, in other embodiments, some or all of usage data 530 may be collected and/or stored by one or more other components of electronic system 400. Usage data 530 may indicate which apps were used with associated time stamps, e.g., a time when an app was opened and a time that the app was closed. Usage data 530 may further indicate one or more people using electronic system 400. For example, different users of electronic system 400 may select a specific profile on the electronic system 400 and/or within an app running on electronic system 400. As another example, electronic system 400 may detect devices in the vicinity of electronic system 400, e.g., based on Bluetooth signals of wearable devices, smartphones, or other devices typically located on or near an individual; these signals may be used to identify different users of electronic system 400.

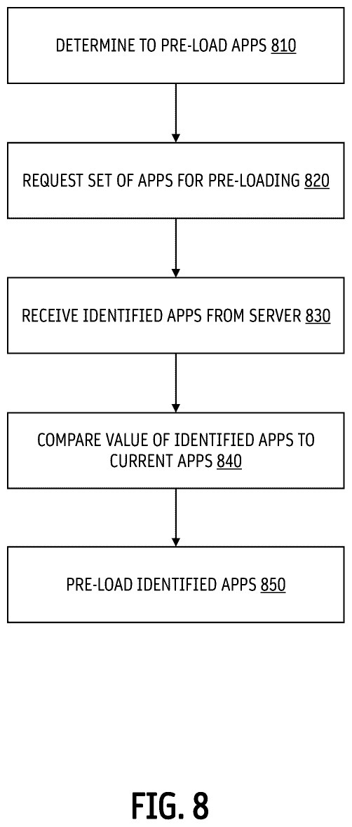

Pre-load manager 532 manages pre-loading of apps on electronic system 400. For example, pre-load manager 532 performs the process illustrated in FIG. 8, described below. Pre-load manager 532 may interface with server 520 to determine whether to pre-load one or more apps in memory 412. Pre-load manager 532 may further interface with data storage 414 and/or web resource 540 to pre-load one or more selected apps into memory 412.

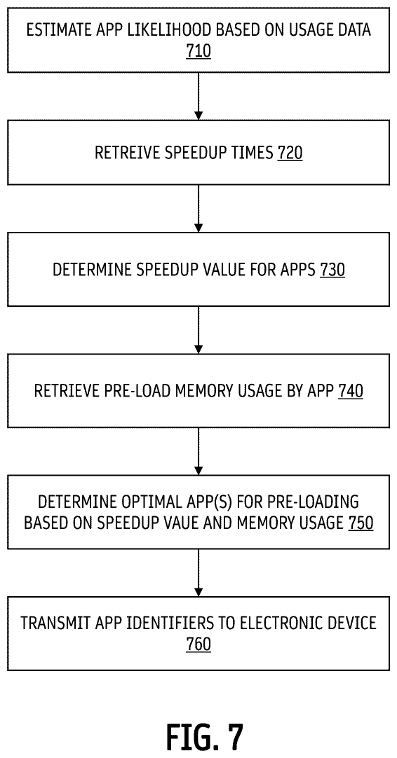

Server 520 may be related to one or more of electronic systems 400. For example, server 520 may provide data to one or more of electronic systems 400 and/or receive data from one or more of electronic systems 400. In this example, server 520 includes components for implementing pre-load system 482 of 400, including a machine-learning module 522, a likelihood model 524, a speedup estimator 526, and a knapsack solver 528. The machine-learning module 522 trains the likelihood model 524 to estimate likelihoods that each of a set of apps is loaded on electronic system 400. The likelihood model 524, speedup estimator 526, and knapsack solver 528 are used to determine a set of one or more apps 110 for pre-loading on a given electronic system 400, based on data received from the electronic system 400. Server 520 may perform the process illustrated in FIG. 7, described below.

Web resource 540 may provide data for one or more applications, e.g., one of the apps 110, executing on the electronic system 400. For example, web resource 540 may provide any app data for executing an app 110 on 400, such as compiled code for the app, UI resources utilized by the app (e.g., assets, layouts, style sheets, etc.), libraries, frameworks, configuration files, RSS feeds, content descriptions, etc. Web resource 540, or an additional web resource, may provide streaming content, e.g., video or audio content for playback by electronic system 400. Different web resources may be associated with different apps, e.g., a first web resource 540 at a first network location is associated with App 1 110a, a second web resource 540 at a second network location is associated with App 2 110b, etc.

### Exemplary Preparatory Method for Pre-Loading App Data

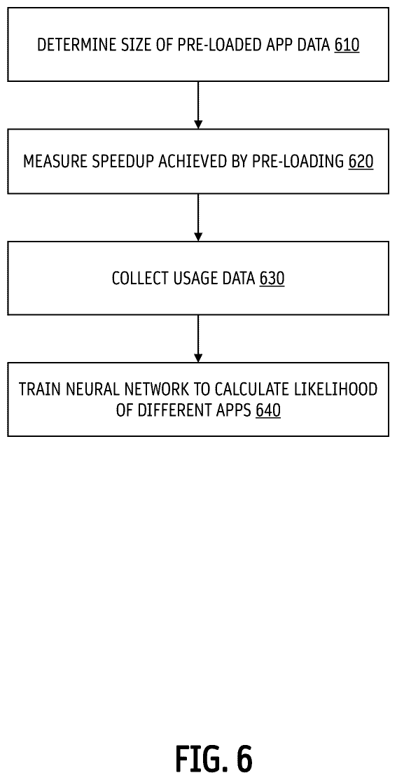

FIG. 6 depicts a flow diagram illustrating exemplary operations for preparing a system for selecting app data for pre-loading, according to some embodiments of the disclosure. The operations may be performed by components in electronic system 400 and server 520.

In 610, electronic system 400 and/or server 520 determines the size of pre-loaded app data. As described with respect to FIGS. 1-3, pre-loading different apps utilizes different amounts of memory 120. Server 520 may collect and store data describing the memory utilization of pre-loading different apps. For example, server 520 may be in communication with a number of different electronic systems 400. When a given electronic system 400 pre-loads an app, that electronic system 400 may determine the size of the pre-load app data and report the memory utilization for pre-loading. Alternatively, server 520 may determine the size of pre-load app data directly based on information from the app provider. Server 520 may store the size of pre-load data for various apps in a database that is accessible to knapsack solver 528.

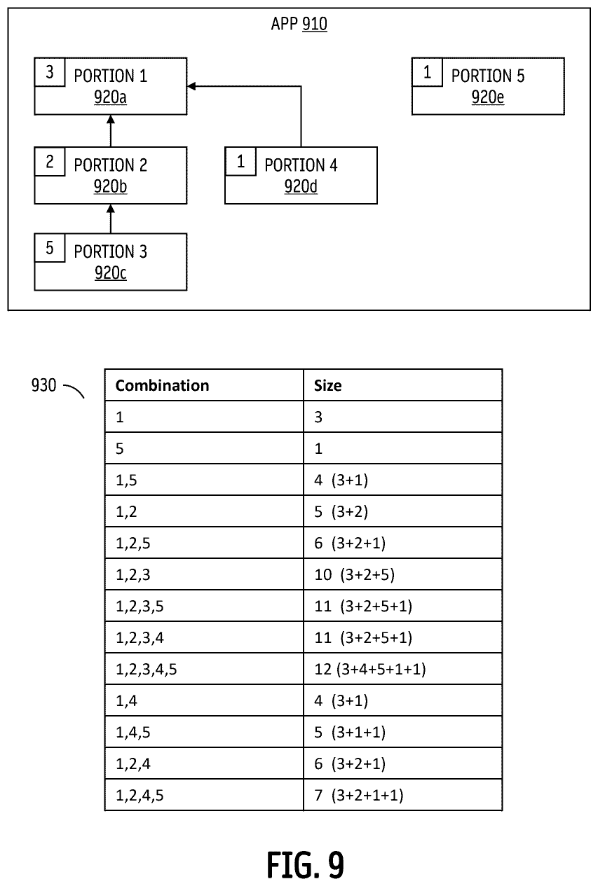

The size of the pre-load app data may vary over time, e.g., based on updates to the app, so the size of pre-load app data may be updated over time, e.g., on a periodic basis, or in response to a new version being released. In some embodiments, for a particular app, the pre-load data may be broken into two or more components, which may be separately pre-loaded. An example is described in relation to FIG. 9. In such embodiments, the size of the various components of pre-load data may be determined and stored at server 520.

In 620, electronic system 400 and/or server 520 measures the speedup achieved by pre-loading app data. For example, one or more electronic systems 400 may measure the amount of time for an app to load without pre-loading, and one or more electronic systems 400 may measure the amount of time for an app to load if app data has been pre-loaded in memory 412. Server 520 may take these measurements and determine, for a given app, the speedup achieved (e.g., in milliseconds or seconds) by pre-loading data. For example, based on measurements across multiple electronic systems 400, server 520 may calculate an average loading time for an app with pre-loading (T_{PL}) and an average loading time for an app without pre-loading (T_{NO PL}). The speedup time may be the difference between these times:

$$Speedup Time = {T}_{NO PL} - {T}_{PL}$$

In some embodiments, server 520 may calculate and store speedup times for different electronic systems 400 or different groups of electronic system 400, e.g., for different models of streaming devices. As noted above, in some embodiments, pre-load data for an app may be broken into two or more components, which may be separately pre-loaded. In such embodiments, the speedup times of the various components of pre-load data may be determined and stored at server 520. In some embodiments, a given electronic system 400 may have certain app data stored on data storage 414, and other data is accessed from web resource 540 in response to a user loading the app. Server 520 may maintain different speedup times depending on whether some or all of the app data is retrieved from data storage 414 or from web resource 540 (e.g., one speedup time to download all app data from a web resource 540, another speedup time to retrieve all app data from data storage 414, and another speedup time to retrieve a portion of app data from the web resource 540 and another portion from data storage 414).

In 630, electronic system 400 collects usage data, e.g., usage data 530 described with respect to FIG. 5. Electronic system 400 may transmit usage data 530 to server 520. Electronic system 400 may transmit usage data 530 on a periodic basis; server 520 may collect and store usage data from a greater length of time than is stored on electronic system 400.

In 640, machine-learning module 522 trains a neural network, here the likelihood model 524, to calculate the likelihood that electronic system 400 loads different apps, i.e., the likelihoods that a user of electronic system 400 selects to load each of a set of different apps available through electronic system 400. The machine-learning module 522 processes usage data 530 to develop one or more machine-learning models, such as likelihood model 524. More particularly, the machine-learning module 522 uses machine learning to identify a set of features that can be used to predict likelihoods for each app. The machine-learning module 522 may use any known machine learning algorithm or combination of algorithms, such as Gaussian process regression (GPR), other Bayesian learning methods, support-vector machines (SVM), artificial neural networks, etc., to training the likelihood model 524.

The likelihood model 524 may be specific to a given electronic system 400, e.g., to a particular streaming device. Server 520 may train individual likelihood models 524 for each electronic system 400. In some embodiments, if an electronic system 400 has multiple users (e.g., multiple profiles), machine-learning module 522 may train a different likelihood model 524 for each user or each profile. In other embodiments, the active user or profile may be one feature input to likelihood model 524 and used to train likelihood model 524. Signals associated with individuals present in the vicinity of electronic system 400 (e.g., identifiers of Bluetooth signals) may be additional features input to likelihood model 524 and used to train likelihood model 524.

The operations in FIG. 6 may be performed in a different order from the order depicted. For example, operations 610, 620, and 630 may be performed independently from each other, e.g., in parallel or at different times. Operation 640 is generally performed after operation 640, but these operations may be repeated; in particular, the neural network may be retrained based on additional or updated usage data 530.

### Exemplary Method for Selecting Apps for Pre-Loading

FIG. 7 depicts a flow diagram illustrating exemplary operations for selecting app data for pre-loading, according to some embodiments of the disclosure. The operations may be performed by server 520. In general, electronic system 400 may be a relatively thin client and many computations are performed at server 520. However, in other embodiments, at least a portion of the operations may be performed at electronic system 400.

In 710, a likelihood model, such as likelihood model 524 of server 520, estimates app likelihoods based on usage data. For example, as described with respect to FIG. 5, the likelihood model 524 is trained based on usage data 530 collected by electronic system 400 to estimate likelihoods that different apps are opened on electronic system 400. Current usage data, such as a current time of day, day of week, one or more users (or data describing the users, such as Bluetooth identifiers), one or more recently used apps (e.g., a current app and/or a last-used app), may be input as features to the likelihood model 524. In some embodiments, the likelihood model 524 may further consider current events (e.g., elections, weather events, sporting events, etc.), where a current or upcoming event may be associated with one or more apps. For example, one or more apps that provide live television streams may have an increased likelihood during certain events, or an app that provides a particular sports game may have an increased likelihood while the game is airing. The likelihood model 524 estimates likelihoods that each of a set of apps (e.g., apps previously loaded on electronic system 400, or apps loaded on electronic system 400 within a certain time frame, e.g., within the last month or the last year) are requested for execution.

In 720, a speedup estimator (e.g., speedup estimator 526 of server 520) or another computing module retrieves speedup times for the apps with the likelihood estimates. In some embodiments, the speedup estimator retrieves speedup times for a portion of the apps, e.g., the portion with likelihoods above a certain threshold (e.g., above 0.1, or the ten apps with the highest likelihood values). As described with respect to FIG. 6, server 520 may have stored speedup times for individual apps based on measured loading times with pre-loading and measured loading times without pre-loading.

In 730, the speedup estimator (e.g., speedup estimator 526 of server 520) or other computing module determines a speedup value for the apps (or a portion of the apps, e.g., the higher-likelihood apps) based on the likelihood estimate and speedup times. For each app, the speedup estimator may numerically combine the speedup time for preloading the app with the likelihood that the app is launched. For example, a speedup value may be calculated by multiplying the speedup time times the likelihood, as follows:

$$Speedup Value = Speedup Time * Likeihood$$

In other embodiments, different formulas for calculating a speedup value based on the speedup value and likelihood may be used. In some embodiments, operation 710 may be performed in parallel with operation 720 and/or operation 730, or operation 710 may be performed after operation 720 and/or operation 730.

In 740, a knapsack solver (e.g., knapsack solver 528 of server 520) or another computing module retrieves pre-load memory usage for the apps with the speedup values. As described with respect to FIG. 6, server 520 may have stored data describing the memory utilization of pre-loading different apps.

In 750, the knapsack solver (e.g., knapsack solver 528 or server 520) or other computing module determines an optimal set of one or more apps to pre-load based on the speedup values and pre-load memory usage. For example, the problem of determining the optimal set of apps may be structured as a 0-1 knapsack problem in which the speedup values correspond to the values, and the sizes (e.g., memory utilization) of the pre-loaded app data correspond to the weights. Knapsack solver 528 may perform any suitable algorithm for solving the knapsack problem. Knapsack solver 528 can use a brute force approach of checking all the possible combinations of apps and selecting the best result. Alternatively, knapsack solver 528 can use a more efficient approach, such a dynamic programming algorithm. Dynamic programming algorithms include a top-down approach with memoization or a bottom-up approach with tabulation. The memoization technique stores the previous function call results in an array, so that previous results can be fetched from that array and are not re-calculated. Alternatively, the bottom-up tablulation approach, also referred to as an iterative approach, solves the problem in a bottom-up manner by filling up a table with the results from the most basic subproblems first; later table values are filled in using the previous results.

In 760, the server (e.g., server 520) transmits identifiers of the set of apps to the electronic device (e.g., electronic system 400) so that the electronic device can pre-load the identified set of apps. If one or more of the set of apps differs from the apps currently available in a memory (e.g., memory 120 or memory 412), electronic system 400 may retrieve app data for the set of apps and pre-load the app data into the memory.

### Exemplary Method for Pre-Loading App Data

FIG. 8 depicts a flow diagram illustrating exemplary operations for initiating pre-loading data selection and pre-loading app data, according to some embodiments of the disclosure. The operations may be performed by electronic system 400. In some embodiments, at least a portion of the operations may be performed at server 520.

At 810, a system (e.g., electronic system 400) determines to pre-load one or more apps into memory. For example, if electronic system 400 is turned on or woken up from an asleep or suspend state, pre-load manager 532 may determine to pre-load one or more apps that the user is likely to open. As another example, if electronic system 400 already has one or more apps pre-loaded in memory 412, pre-load manager 532 may determine to evaluate whether the currently pre-loaded apps are an optimal set of apps and, if not, may pre-load one or more different apps. Pre-load manager 532 may determine to evaluate the pre-loaded app or apps in response to a change to one or more inputs to a model used to select a set of apps for pre-loading. Pre-load manager 532 may determine to pre-load apps (or potentially change currently pre-loaded apps) in response to determining that a user of electronic system 400 is likely to load an app. For example, if electronic system 400 detects that a user or potential user of electronic system 400 is in the vicinity of electronic system 400, pre-load manager 532 may determine to request a set of apps for pre-loading from server 520. As another example, if pre-load manager 532 or another process on electronic system 400 determines that a currently-playing content item is nearing its end time, pre-load manager 532 may determine to request a set of apps for pre-loading from server 520.

At 820, the system (e.g., pre-load manager 532 of electronic system 400) requests a set of one or more apps for preloading. In particular, pre-load manager 532 transmits a request to server 520 to return data identifying a set of one or more optimal apps for pre-loading into memory 412. The request may include data identifying electronic system 400 and/or properties of electronic system 400, e.g., a model number of electronic system 400, or an amount of space in memory 412 that is available for pre-loading apps. In some embodiments, the request may further include data identifying one or more apps currently loaded and/or pre-loaded onto memory 412 of electronic system 400. As another example, the request may include data identifying one or more apps currently stored in data storage 414; the speedup value (and, in particular, the speedup time) may vary based on whether app data is accessed from data storage 414 as opposed to web resource 540.

At 830, the system (e.g., pre-load manager 532 of electronic system 400) receives data describing a set of one or more identified apps from server 520. Server 520 may have performed the operations described with respect to FIG. 7 to select the set of one or more apps based on the likelihoods of loading the apps and memory space used for pre-loading the apps.

At 840, the system (e.g., pre-load manager 532 of electronic system 400) compares the value of the set of apps identified by server 520. Pre-load manager 532 may change the pre-loaded apps if the identified set of apps provide a first value that is greater than a second value of the currently loaded and/or pre-loaded apps by at least a threshold amount. For example, a first total speedup value (where speedup value is calculated as described with respect to FIG. 7) of the set of apps identified by server 520 may be compared to a second total speedup value of the current set of loaded/pre-loaded apps. For example, if a difference between the first total speedup value and the second total speedup value is greater than a threshold amount, pre-load manager 532 may determine to pre-load the set of apps identified by server 520. Otherwise, pre-load manager 532 may leave the current set of loaded/pre-loaded app in memory 412. In some embodiments, the operation 840 is performed at server 520, and the decision of whether to pre-load the identified set of apps is transmitted to electronic system 400.

At 850, if pre-load manager 532 (or server 520) has determined to pre-load the new set of identified apps, pre-load manager 532 instructs pre-loading of the identified apps. First, pre-load manager 532 may determine whether any of the identified apps are currently loaded (e.g., if currently being executed) or pre-loaded into memory 412. For any apps in memory 412 that are not being presently utilized or included in the set of apps for pre-loading, pre-load manager 532 may remove any pre-loaded app data. For any app in the set of apps for pre-loading that are not already loaded or pre-loaded, pre-load manager 532 retrieves the app data for pre-loading and stores the app data into memory 412. Pre-load manager 532 may retrieve the app data from data storage 414 if the app data is present in data storage 414. Alternatively, pre-load manager 532 may retrieve the app data from web resource 540.

### Exemplary App Data With Multiple Subcomponents

In some embodiments, for a particular app, the pre-load data may be broken into two or more components, and one or more components of app data may be pre-loaded. In such embodiments, rather than pre-loading app data for, say, App 1 110a and App 2 110b into memory 120, a portion of app data for App 1 110a, portion of app data for App 2 110b, a portion of app data for App 3 110c, and a portion of app data for App 4 110d may be pre-loaded.

FIG. 9 illustrates example data components of an app that may be separately pre-loaded and a set of pre-loading combinations associated with the data components, according to some embodiments of the disclosure. In FIG. 9, app 910 includes five portions 920a-920e of app data. Each portion 920 may correspond to a different type of app data. For example, portion 1 920a may describe UI elements for a home screen, and portion 2 920b may include data elements for displaying in the home screen. The arrows between portions 920 illustrate dependencies, more generally, an order in which different portions of app data are used. For example, the app may not access the data elements, represented in portion 2 920b, until after the home screen UI elements, represented in portion 1 920a, are loaded. As another example, portion 5 950a may represent a splash screen. While the home UI is displayed after the splash screen, the home screen UI elements may be loaded into memory 120 concurrently with the splash screen, so there is not a dependency between these two portions 920a and 920e.

Memory areas used by the different portions 920 are represented in the upper-right of each box. For example, portion 1 920a has a size of 3, and portion 2 920b has a size of 2. The portions 920 may be pre-loaded in different combinations. In some cases, server 520 may consider each possible combination of portions 920, e.g., for the five portions 920, there are 31 possible combinations of the portions (some of which may be over the maximum capacity in memory). In other cases, the dependencies may be used to determine combinations that may be considered by knapsack solver 528. For example, table 930 illustrates different unordered combinations of portions 920 of data that may be pre-loaded for app 910. Table 930 also provides a total size for each combination. In this example, given the dependencies, there are 13 possible combinations of the portions 920. Thus, using the dependencies to generate the combinations, rather than considering all possible combinations, can reduce the number of combinations to be considered.

The speedup estimator 526 may consider the speedup time for each possible combination, apply the likelihood for app 910 to each combination, and use knapsack solver 528 to select whether to include a given combination of portions 910. As another example, rather considering the dependencies as described above, speedup estimator 526 may evaluate the speedup time for each possible combination of portions 920 (e.g., for the 31 possible combinations in the example with 5 data portions) and select a portion of the combinations for considering in knapsack solver 528 based on the speedup times. For example, for each different combined size, or for each of a set of size ranges (e.g., 100-200 MB, 200-300 MB, 300-400 MB, and so forth), server 520 may select a combination with the combined size that offers the greatest speedup time.

Having identified a subset of the combinations of portions and the associated speedup time, knapsack solver 528 may determine which apps and, for each app, which portion(s) of app data to pre-load. Knapsack solver 528 may be constrained to include, for a given app, only one set of pre-load portions. For example, if knapsack solver 528 considers 5 apps, each having pre-load data that can be segmented into 5 portions, knapsack solver 528 returns a solution that includes, for each app, either no pre-load data or 1 set of pre-load data. As another example, knapsack solver 528 can be constrained to include non-overlapping sets of pre-load data for a given app, so that the same data is not pre-loaded twice.

### Example Computing Device

FIG. 10 depicts a block diagram of an exemplary computing device 1000, according to some embodiments of the disclosure. One or more computing devices, such as computing device 1000, may be used to implement the functionalities described with reference to the FIGS. and herein. A number of components are illustrated in the FIGS. as included in computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single system on a chip (SoC) die. Additionally, in various embodiments, the computing device 1000 may not include one or more of the components illustrated in FIG. 10, and the computing device 1000 may include interface circuitry for coupling to the one or more components. For example, the computing device 1000 may not include a display device 1006, and may include display device interface circuitry (e.g., a connector and driver circuitry) to which a display device 1006 may be coupled. In another set of examples, the computing device 1000 may not include an audio input device 1018 or an audio output device 1008 and may include audio input or output device interface circuitry (e.g., connectors and supporting circuitry) to which an audio input device 1018 or audio output device 1008 may be coupled.

The computing device 1000 may include a processing device 1002 (e.g., one or more processing devices, one or more of the same type of processing device, one or more of different types of processing device). The processing device 1002 may include electronic circuitry that process electronic data from data storage elements (e.g., registers, memory, resistors, capacitors, quantum bit cells) to transform that electronic data into other electronic data that may be stored in registers and/or memory. Examples of processing device 1002 may include a central processing unit (CPU), a graphical processing unit (GPU), a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 1000 may include a memory 1004, which may itself include one or more memory devices such as volatile memory (e.g., DRAM), non-volatile memory (e.g., read-only memory (ROM)), high bandwidth memory (HBM), flash memory, solid state memory, and/or a hard drive. Memory 1004 includes one or more non-transitory computer-readable storage media. In some embodiments, memory 1004 may include memory that shares a die with the processing device 1002. In some embodiments, memory 1004 includes one or more non-transitory computer-readable media storing instructions executable to perform operations described with the FIGS., such as operations described with software 104 (e.g., including one or more of: operating system 180, Application A 160, and Application B 162). The instructions stored in the one or more non-transitory computer-readable media may be executed by processing device 1002. In some embodiments, memory 1004 may store data, e.g., data structures, binary data, bits, metadata, files, blobs, etc., as described with the FIGS. and herein.

In some embodiments, the computing device 1000 may include a communication device 1012 (e.g., one or more communication devices). For example, communication device 1012 may be configured for managing wired and/or wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1012 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP 2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1012 may operate in accordance with other wireless protocols in other embodiments. The computing device 1000 may include an antenna 1022 to facilitate wireless communications and/or to receive other wireless communications (such as radio frequency transmissions). The computing device 1000 may include receiver circuits and/or transmitter circuits. In some embodiments, the communication device 1012 may manage wired communications, such as electrical, optical, or any other suitable communication protocols (e.g., the Ethernet). As noted above, communication device 1012 may include multiple communication chips. For instance, a first communication device 1012 may be dedicated to shorter-range wireless communications such as Wi-Fi or Bluetooth, and a second communication device 1012 may be dedicated to longer-range wireless communications such as global positioning system (GPS), EDGE, GPRS, CDMA, WiMAX, LTE, EV-DO, or others. In some embodiments, a first communication device 1012 may be dedicated to wireless communications, and a second communication device 1012 may be dedicated to wired communications.

The computing device 1000 may include power source/power circuitry 1014. The power source/power circuitry 1014 may include one or more energy storage devices (e.g., batteries or capacitors) and/or circuitry for coupling components of the computing device 1000 to an energy source separate from the computing device 1000 (e.g., DC power, AC power, etc.).

The computing device 1000 may include a display device 1006 (or corresponding interface circuitry, as discussed above). Display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include a sensor 1030 (or one or more sensors). The computing device 1000 may include corresponding interface circuitry, as discussed above). Sensor 1030 may sense physical phenomenon and translate the physical phenomenon into electrical signals that can be processed by, e.g., processing device 1002. Examples of sensor 1030 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1000 may include another output device 1010 (or corresponding interface circuitry, as discussed above). Examples of the other output device 1010 may include an audio codec, a video codec, a printer, a wired or wireless transmitter for providing information to other devices, haptic output device, gas output device, vibrational output device, lighting output device, home automation controller, or an additional storage device.

The computing device 1000 may include another input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1000 may have any desired form factor, such as a handheld or mobile computer system (e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 1000 may be any other electronic device that processes data.

### Select Examples

Example 1 provides a method including determining a likelihood of a device launching each of a plurality of apps; calculating a speedup value for launching each of the plurality of apps, where the speedup values are calculated based on the determined likelihoods; retrieving a memory allotment for pre-loading data for each of the plurality of apps; selecting at least one app from of the plurality of apps for pre-loading data into memory based on the speedup values and the memory allotments; and transmitting data identifying the selected at least one app to a device, the device to pre-load data for the selected at least one app into a memory.
Example 2 provides the method of example 1, where determining the likelihood of a device launching each of a plurality of apps includes inputting a set of features to a trained neural network, the set of features including a time of day, a day of the week, and a recently-used app; and receiving, from the neural network, a likelihood associated with each of the plurality of apps.
Example 3 provides the method of example 1 or 2, where the memory is a random-access memory (RAM).
Example 4 provides the method of example 3, where an amount of available storage on the RAM for pre-loading app data is less than a total amount of pre-loading data for each of the plurality of apps.
Example 5 provides the method of any one of examples 1-4, where calculating the speedup value for launching each of the plurality of apps includes retrieving a measured speedup achieved by pre-loading data for one of the plurality of apps; and multiplying the measured speedup by the likelihood of the device launching the one of the plurality of apps.
Example 6 provides the method of any one of examples 1-5, where selecting the at least one app from of the plurality of apps for pre-loading data into memory based on the speedup values and the memory allotments includes solving a knapsack problem in which pre-loaded data for an app is an item, the memory allotment for an app is its weight, and the speedup value for an app is its value.
Example 7 provides the method of any one of examples 1-6, where one of the plurality of apps includes two segments of data for pre-loading, and the method further includes selecting one segments or both segments of the data for pre-loading.
Example 8 provides the method of any one of examples 1-7, where the selected at least one app is a first app set having a first total pre-loading value, the method further including identifying a second app set, where data of each app of the second app set is currently pre-loaded in the memory of the device; determining a second total pre-loading value of the second app set; comparing the first total pre-loading value to the second total pre-loading value; and instructing the device to pre-load data for first app set into the memory of the device in response to determining that the first total pre-loading value is greater than the second total pre-loading value by at least a threshold amount.
Example 9 provides a method including transmitting, from a streaming device, a request to a server for a set of at least one app for pre-loading into a memory of the streaming device; receiving, from the server, data describing the set of at least one app for pre-loading into a memory, the set selected from a plurality of apps available on the streaming device based on usage data of the streaming device; retrieving app data corresponding to the at least one app; and storing the retrieved app data in the memory of the streaming device.
Example 10 provides the method of example 9, where selecting the set from the plurality of apps available on the streaming device includes determining a likelihood of the streaming device launching each of the plurality of apps; calculating a speedup value for launching at least a portion of the plurality of apps, where the speedup values are calculated based on the determined likelihoods; and selecting the set of at least one app for pre-loading into the memory based on the speedup values.
Example 11 provides the method of example 10, where selecting the set from the plurality of apps available on the streaming device further includes retrieving a memory allotment for pre-loading data for at least the portion of the plurality of apps; and selecting the set of at least one app for pre-loading into the memory further based on the memory allotments.
Example 12 provides the method of any one of examples 9-11, further including determining to evaluate pre-loaded apps in response to determining that at least one input to a likelihood model for determining a likelihood of different apps being requested has changed; and transmitting the request to the server for the set of at least one app for pre-loading in response to determining to evaluate the pre-loaded apps.
Example 13 provides the method of any one of examples 9-12, further including determining to pre-load one or more apps in response to determining, based on user activity or streaming activity, that a user is likely to initiate execution of an app; and transmitting the request to the server for the set of at least one app for pre-loading in response to determining to pre-loaded one or more apps.
Example 14 provides the method of any one of examples 9-13, where retrieving app data corresponding to the at least one app includes retrieving app data from a web resource external to the streaming device.
Example 15 provides the method of any one of examples 9-14, where retrieving app data corresponding to the at least one app includes retrieving app data from local storage of the streaming device.

Example 16 provides a device including a memory; and a processing component coupled to the memory, the processing component to: determine to transmit a request to a server for a set of at least one app for pre-loading into the memory; receive data describing the set of at least one app for pre-loading into the memory, the set selected from a plurality of apps available on the device based on usage data of the device; retrieve app data corresponding to the at least one app; and store the retrieved app data in the memory.
Example 17 provides the device of example 16, where the plurality of apps available on the device include apps that have been previously executed on the device, and a total amount of pre-load data for the apps that have been previously executed on the device exceeds a capacity of the memory.
Example 18 provides the device of example 16 or 17, where selecting the set from the plurality of apps available on the device includes determining a likelihood of the device launching each of the plurality of apps; calculating a speedup value for launching at least a portion of the plurality of apps, where the speedup values are calculated based on the determined likelihoods; and selecting the set of at least one app for pre-loading into the memory based on the speedup values.
Example 19 provides the device of example 18, where selecting the set from the plurality of apps available on the device further includes retrieving a memory allotment for pre-loading data for at least the portion of the plurality of apps; and selecting the set of at least one app for pre-loading into the memory further based on the memory allotments.
Example 20 provides the device of any one of examples 16-19, where the processing component is to determine to transmit a request to a server for a set of at least one app for pre-loading into the memory in response to: determining that at least one input to a likelihood model for determining a likelihood of different apps being requested has changed; or determining, based on user activity or streaming activity, that a user is likely to initiate execution of an app.
Example A provides one or more non-transitory computer-readable media storing instructions that, when executed by one or more processors, cause the one or more processors to perform any one of the methods described herein.
Example B provides an apparatus comprising means to carry out or means for carrying out any one of the methods provided in examples 1-20, and/or any one of the methods described herein.
Example C provides a computer-implemented system, comprising one or more processors, and one or more non-transitory computer-readable media storing instructions that, when executed by the one or more processors, cause the one or more processors to perform any one of the methods provided in examples 1-20 and/or any one of the methods described herein.
Example D provides a computer-implemented system comprising one or more components illustrated in FIG. 1 to perform operations described herein.
Example E provides a computing device comprising one or more components illustrated in FIG. 10 to perform operations described herein.

### Variations and Other Notes

The description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the above detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method comprising:
determining a likelihood of a device launching each of a plurality of apps;
calculating a speedup value for launching each of the plurality of apps, wherein the speedup values are calculated based on the determined likelihoods;
retrieving a memory allotment for pre-loading data for each of the plurality of apps;
selecting at least one app from of the plurality of apps for pre-loading data into memory based on the speedup values and the memory allotments; and
transmitting data identifying the selected at least one app to a device, the device to pre-load data for the selected at least one app into a memory.

2. The method of claim 1, wherein determining the likelihood of a device launching each of a plurality of apps comprises:
inputting a set of features to a trained neural network, the set of features comprising a time of day, a day of the week, and a recently-used app; and
receiving, from the neural network, a likelihood associated with each of the plurality of apps.

3. The method of claim 1, wherein the memory is a random-access memory (RAM).

4. The method of claim 3, wherein an amount of available storage on the RAM for pre-loading app data is less than a total amount of pre-loading data for each of the plurality of apps.

5. The method of claim 1, wherein calculating the speedup value for launching each of the plurality of apps comprises:
retrieving a measured speedup achieved by pre-loading data for one of the plurality of apps; and
multiplying the measured speedup by the likelihood of the device launching the one of the plurality of apps.

6. The method of claim 1, wherein selecting the at least one app from of the plurality of apps for pre-loading data into memory based on the speedup values and the memory allotments comprises solving a knapsack problem in which pre-loaded data for an app is an item, the memory allotment for an app is its weight, and the speedup value for an app is its value.

7. The method of claim 1, wherein one of the plurality of apps comprises two segments of data for pre-loading, and the method further comprises selecting one segments or both segments of the data for pre-loading.

8. The method of claim 1, wherein the selected at least one app is a first app set having a first total pre-loading value, the method further comprising:
identifying a second app set, wherein data of each app of the second app set is currently pre-loaded in the memory of the device;
determining a second total pre-loading value of the second app set;
comparing the first total pre-loading value to the second total pre-loading value; and
instructing the device to pre-load data for first app set into the memory of the device in response to determining that the first total pre-loading value is greater than the second total pre-loading value by at least a threshold amount.

9. A method comprising:
transmitting, from a streaming device, a request to a server for a set of at least one app for pre-loading into a memory of the streaming device;
receiving, from the server, data describing the set of at least one app for pre-loading into a memory, the set selected from a plurality of apps available on the streaming device based on usage data of the streaming device;
retrieving app data corresponding to the at least one app; and
storing the retrieved app data in the memory of the streaming device.

10. The method of claim 9, wherein selecting the set from the plurality of apps available on the streaming device comprises:
determining a likelihood of the streaming device launching each of the plurality of apps;
calculating a speedup value for launching at least a portion of the plurality of apps, wherein the speedup values are calculated based on the determined likelihoods; and
selecting the set of at least one app for pre-loading into the memory based on the speedup values.

11. The method of claim 10, wherein selecting the set from the plurality of apps available on the streaming device further comprises:
retrieving a memory allotment for pre-loading data for at least the portion of the plurality of apps; and
selecting the set of at least one app for pre-loading into the memory further based on the memory allotments.

12. The method of claim 9, further comprising:
determining to evaluate pre-loaded apps in response to determining that at least one input to a likelihood model for determining a likelihood of different apps being requested has changed; and
transmitting the request to the server for the set of at least one app for pre-loading in response to determining to evaluate the pre-loaded apps.

13. The method of claim 9, further comprising:
determining to pre-load one or more apps in response to determining, based on user activity or streaming activity, that a user is likely to initiate execution of an app; and
transmitting the request to the server for the set of at least one app for pre-loading in response to determining to pre-loaded one or more apps.

14. The method of claim 9, wherein retrieving app data corresponding to the at least one app comprises retrieving app data from a web resource external to the streaming device.

15. The method of claim 9, wherein retrieving app data corresponding to the at least one app comprises retrieving app data from local storage of the streaming device.

16. A device comprising:
a memory; and
a processing component coupled to the memory, the processing component to:
determine to transmit a request to a server for a set of at least one app for pre-loading into the memory;
receive data describing the set of at least one app for pre-loading into the memory, the set selected from a plurality of apps available on the device based on usage data of the device;
retrieve app data corresponding to the at least one app; and
store the retrieved app data in the memory.

17. The device of claim 16, wherein the plurality of apps available on the device comprise apps that have been previously executed on the device, and a total amount of pre-load data for the apps that have been previously executed on the device exceeds a capacity of the memory.

18. The device of claim 16, wherein selecting the set from the plurality of apps available on the device comprises:
determining a likelihood of the device launching each of the plurality of apps;
calculating a speedup value for launching at least a portion of the plurality of apps, wherein the speedup values are calculated based on the determined likelihoods; and
selecting the set of at least one app for pre-loading into the memory based on the speedup values.

19. The device of claim 18, wherein selecting the set from the plurality of apps available on the device further comprises:
retrieving a memory allotment for pre-loading data for at least the portion of the plurality of apps; and
selecting the set of at least one app for pre-loading into the memory further based on the memory allotments.

20. The device of claim 16, wherein the processing component is to determine to transmit a request to a server for a set of at least one app for pre-loading into the memory in response to:
determining that at least one input to a likelihood model for determining a likelihood of different apps being requested has changed; or
determining, based on user activity or streaming activity, that a user is likely to initiate execution of an app.
